(19) United States
(12) Patent Application Publication
(10) Pub. No.: US 2010/0207886 A1
(43) Pub. Date: Aug. 19, 2010

(54) APPARATUS AND METHOD FOR REDUCING BATTERY POWER CONSUMPTION IN A PORTABLE TERMINAL

(75) Inventor: Kwang-Hee RYU, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/701,872

(22) Filed: Feb. 8, 2010

(30) Foreign Application Priority Data
Feb. 13, 2009 (KR) 10-2009-0012029

(51) Int. Cl. G09G 5/08; G09G 5/10; G06F 3/033

(52) U.S. Cl. 345/166; 345/690

(57) ABSTRACT

An apparatus for reducing battery power consumption of a portable terminal are provided. The apparatus and the method uses information surrounding a mouse function as a value of a light sensor to adjust an LCD brightness. The apparatus includes a sensor part for determining first sensing information for determining whether a function using ambient brightness information operates, and second sensing information for determining the ambient brightness; wherein an adjustment to a screen brightness of the portable terminal is made using the second sensing information when the first sensing information is not operative.

### CLAIM OF PRIORITY

This application claims the benefit of an earlier Korean patent application filed in the Korean Intellectual Property Office on Feb. 13, 2009 and assigned Serial No. 10-2009-0012029, the entire disclosure of which is hereby incorporated by reference in its entirety.

### BACKGROUND OF THE INVENTION

1. Field of the Invention

The present invention relates generally to an apparatus and a method for reducing battery power consumption of a portable terminal. More particularly, the present invention relates to an apparatus and a method for using an optical mouse embodied in the portable terminal as a light sensor to regulate a Liquid Crystal Display (LCD) brightness.

2. Description of the Related Art

A rapid advance in recent years enabled portable terminals to provide wireless voice communication and data exchange which has become one of the necessities in life. In the early days of the portable terminal, people just recognized the portable medium to provide a wireless phone call. As the technology improved and due to a rampant use of wireless interne, the application of the portable terminal now allow a variety of other applications, such as games, satellite broadcast viewing, remote controller using a short range communication, image capture using an embedded digital camera, and schedule management.

However, there has not been a great deal of advance in the field of battery as users demand smaller terminal.

To support a number of functions of the portable terminal with the limited battery capacity, it is necessary to increase the battery capacity while reducing the battery power consumption.

A considerable power consumption in the portable terminal is associated with music play, video viewing, camera, backlight illumination, and the like. To reduce the power consumption, the brightness of a portable display is adjusted based on the ambient brightness. For example, during a day time, the portable terminal lowers the brightness of the display but increases the brightness at night. Alternatively, the portable terminal regulates the brightness of the display part by classifying the brightness of the light using a light sensor, which adjusts illumination based on the brightness of the light and controlling the current of the backlight.

However, to control the current of the backlight, the light sensor for detecting the brightness of the light is separately required, which increases the manufacturing cost of the portable terminal.

### SUMMARY OF THE INVENTION

An exemplary aspect of the present invention is to provide an apparatus and a method for reducing battery power consumption of a portable terminal.

Another exemplary aspect of the present invention is to provide an apparatus and a method for regulating an LCD brightness without using an additional light sensor in a portable terminal.

Yet another exemplary aspect of the present invention is to provide an apparatus and a method for determining an ambient brightness using the optical mouse embodied in the portable terminal as the light sensor in the certain condition.

In accordance with an exemplary aspect of the present invention, an apparatus for reducing battery power consumption in a portable terminal includes a sensor for detecting a first information for determining an object input, and a second information for determining the ambient brightness, and a controller for selectively adjusting a screen brightness of the portable terminal using the second information when the first information indicates absence of the object input.

In accordance with another exemplary aspect of the present invention, a method for reducing a battery power consumption in a portable terminal comprises determining a first information for sensing an object input, determining a second information for determining an ambient brightness, and adjusting a screen brightness of the portable terminal using the second information when the first information indicates absence of the object input.

Other exemplary aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary aspects, features and advantages of certain exemplary embodiments the present invention will become more apparent from the following detailed description taken in conjunction with the accompanying drawings, in which:

FIG. 1 is a diagram of a portable terminal for reducing battery power consumption according to an exemplary embodiment of the present invention;

FIG. 2 is a flowchart of a method for reducing the battery power consumption in the portable terminal according to an exemplary embodiment of the present invention; and

FIG. 3 is a flowchart of a method for reducing the battery power consumption in the portable terminal according to another exemplary embodiment of the present invention.

Throughout the drawings, like reference numerals will be understood to refer to like parts, components and structures.

### DETAILED DESCRIPTION

The following description with reference to the accompanying drawings is provided to assist in a comprehensive understanding of exemplary embodiments of the present invention as defined by the appended claims. The description includes various specific details to assist a person of ordinary skill the art understanding the claimed invention, but these are to be regarded as merely exemplary. Accordingly, those of ordinary skill in the art will recognize that various changes and modifications of the illustrative examples described herein can be made without departing from the spirit of the invention and the scope of the appended claims. For the purpose of simplicity and to avoid redundancy, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural references unless the context clearly dictates otherwise. Thus, for example, a reference to “a component surface” includes reference to one or more of such surfaces.

By the term “substantially” it is typically meant that the recited characteristic, parameter, or value need not be achieved exactly, but that deviations or variations, including but in no way limited to, for example, tolerances, measurement error, measurement accuracy limitations and other factors known to persons of ordinary skill in the art, may occur in amounts that do not preclude the effect the characteristic was intended to provide.

Exemplary embodiments of the present invention provide an apparatus and a method for regulating an LCD brightness based on a brightness around the optical mouse without using a separate light sensor, so as to reduce battery power consumption of a portable terminal.

Herein, the portable terminal uses the optical mouse embodied in the portable terminal to carry out a specific function such as mouse function in a computer. When the specific function is not conducted, the portable terminal reduces the battery power consumption using the sensing information of the optical mouse in lieu of a light sensor for regulating the LCD brightness.

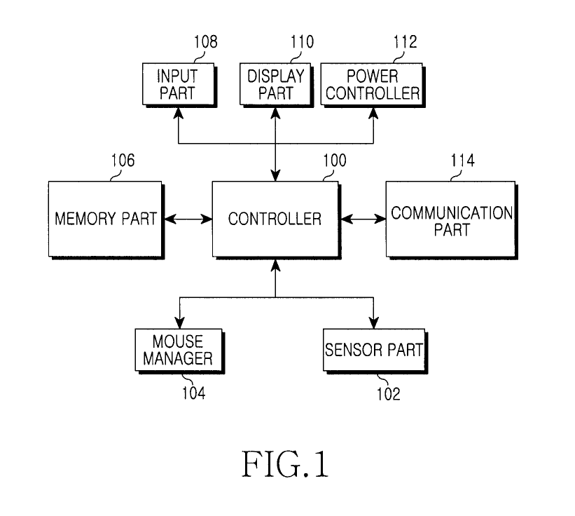

FIG. 1 is a block diagram of a portable terminal whereto the teachings of reducing the battery power consumption according to an exemplary embodiment of the present invention is applied.

The portable terminal shown FIG. 1 operates a specific function such as mouse function based on a specific sensed information. When not performing the specific function, the portable terminal reduces the battery power consumption by regulating the LCD brightness using the information sensed therein. A detailed description of teachings of the present invention will be explained hereinafter.

As shown in FIG. 1, the portable terminal includes a controller 100, a sensor part 102, a mouse manager 104, a memory part 106, an input part 108, a display part 110, a power controller 112, and a communication part 114. Herein, the sensor part is an optical mouse.

The controller 100 of the portable terminal controls over all operations of the portable terminal. For example, the controller 100 processes and controls voice communication and data communication. In addition to the communicative functions, the controller 100 determines to execute a specific function provided from the portable terminal, based on the information from the sensor part 102 and determines whether the specific function of the portable terminal can be activated.

Upon determining a the specific function of the portable terminal is not operative, the controller 100 in turn operates to reduce the battery power consumption of the portable terminal associated with the specific function in order to lower the overall power consumption.

For example, when the portable terminal provides a mouse function for a graphical interface using ambient brightness information, the controller 100 receives a Shutter value indicative of the amount of the light around the mouse from the sensor part 102, utilizes the received Shutter value as the sensing value of the light sensor, and regulates the LCD brightness corresponding to the ambient brightness (whether the portable terminal lies in the dark place or in the bright place), thus reducing the battery power consumption.

The sensor part 102 includes sensors for acquiring the sensing information (e.g., first sensing information for determining whether to execute the function using the ambient brightness information and second sensing information for determining the ambient brightness) required for the mouse function of the portable terminal. The sensor part 102 measures the values indicative of the light amount around the mouse which is used to activate the function of the portable terminal; that is, a Squal value for determining a change in brightness as a user's hand or finger is in contact with or close to the surface of the terminal. For example, the portable terminal comprises an optical mouse for detecting a brightness around the optical mouse for determining an object input. If the brightness is below the threshold brightness for determining an object input, the detected brightness is transmitted to a controller; and the controller in turn adjusts a screen brightness of the portable terminal based on the detected brightness level. Note that the optical mouse provides a pointing function on a display screen of the portable terminal if the brightness is not below the threshold brightness.

The mouse manager 104 processes the mouse function provided from the portable terminal. The mouse manager 104 determines whether the user of the portable terminal intends to use the mouse function, and processes to move a mouse cursor corresponding to the user's input.

The memory part 106 of the portable terminal includes a Read Only Memory (ROM), a Random Access Memory (RAM), and a flash ROM. The ROM stores microcodes and various reference data of programs for processing and controlling the controller 100 and the mouse manager 104.

The RAM stores temporary data generating in the program execution. The flash ROM stores a phone book, sending messages, and received messages, and information indicative of the ambient brightness value with respect to the display part screen brightness.

The input part 108 includes a plurality of function keys such as numeral key buttons 0˜9, menu button, cancel button, OK button, call button, end button, internet access button, navigation key (or direction key) buttons, and character input keys, and provides key input data corresponding to the key pressed by the user to the controller 100.

The display part 110 displays state information in the operation of the portable terminal, a limited number of characters, videos and still images. The display part 110 can employ a color Liquid Crystal Display (LCD). The display part 110 can include a touch input device and be used as the input device in the touch-type portable terminal.

The power controller 112 processes to regulate the brightness of the display part 110 (e.g., LCD) under the direction of the controller 100, to selectively reduce the battery power consumption of the portable terminal.

For instance, when the controller 100 determines the portable terminal operates in a bright environment, the power controller 112 processes to decrease the brightness of the display part 110. When the portable terminal operates in a darker environment, the power controller 112 processes to increase the brightness of the display part 110.

When the display part 112 is an LCD, it is necessary to increase the brightness under the sun because it is hard to see the LCD. In the dark place, the less bright LCD can be easily viewed, thus the LCD can be dimmed.

The communication part 114 functions to transmit and receive radio signals of data input and output via an antenna (not shown). For example, in the transmission mode, the communication part 114 channel-codes, spreads, Radio Frequency (RF)-processes, and then sends data to transmit. In the reception mode, the communication part 114 converts the received RF signal to a baseband signal and restores data by de-spreading and channel-decoding the baseband signal.

The portable terminal reduces the battery power consumption by regulating the brightness of the display part according to the ambient brightness of the portable terminal. Without using a separate light sensor for determining the ambient brightness of the portable terminal, the manufacturing cost and the implementation of the portable terminal can be simplified by using the light information around the optical mouse.

In alternate embodiment, while the controller 100 of the portable terminal can function as the mouse manager 104 and the power controller 112, one skilled in the art shall appreciate that various modification can be made without departing from the spirit and the scope of the invention. For example, the controller 100 may process all of the functions of the mouse manager 104 and the power controller 112.

So far, the apparatus for regulating the LCD brightness based on the ambient brightness without a separate light sensor, by using the information provide via the optical mouse function so as to reduce the battery power consumption of the portable terminal has been explained. Now, descriptions provide a method for regulating the LCD brightness based on the ambient brightness without requiring a separate light sensor.

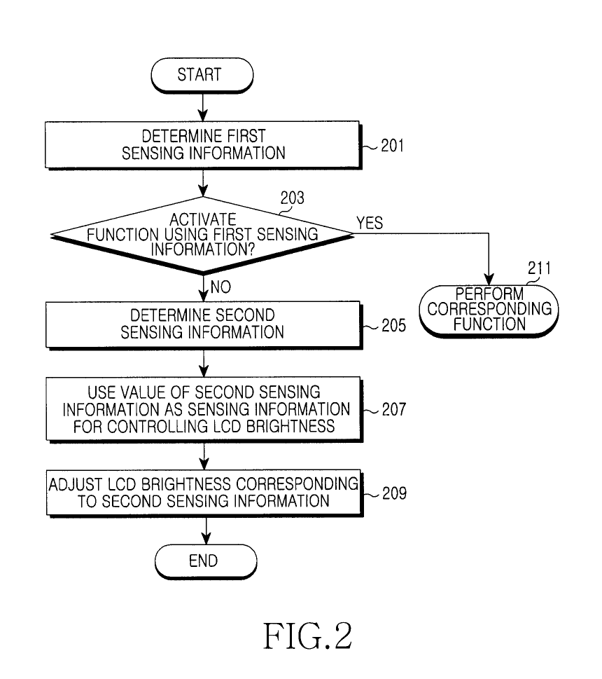

FIG. 2 is a flowchart of the method for reducing the battery power consumption in the portable terminal according to an exemplary embodiment of the present invention.

In step 201, the portable terminal determines a first sensing information. Herein, the first sensing information indicates the information provided from the portable terminal For example, when the portable terminal supports the optical mouse function, the first sensing information indicates the sensing information for determining whether the user's input relates to the mouse function execution.

In step 203, the portable terminal determines whether it can activate the particular function of the portable terminal using the first sensing information.

When determining that the particular function of the portable terminal can be activated using the first sensing information in step 203, the portable terminal performs the corresponding function in step 211.

If not, in step 203, the portable terminal determines the second sensing information in step 205.

Herein, the second sensing information indicates the information (e.g., the current brightness detected via the optical mouse) for determining to control the operation which generates the power consumption in the portable terminal so as to reduce the battery power consumption of the portable terminal.

In step 207, the portable terminal regulates the LCD brightness corresponding to the second sensing information in step 209. That is, using the second sensing information determined in step 205, the portable terminal determines whether to decrease or increase the brightness of the LCD, and then operates correspondingly as explained earlier.

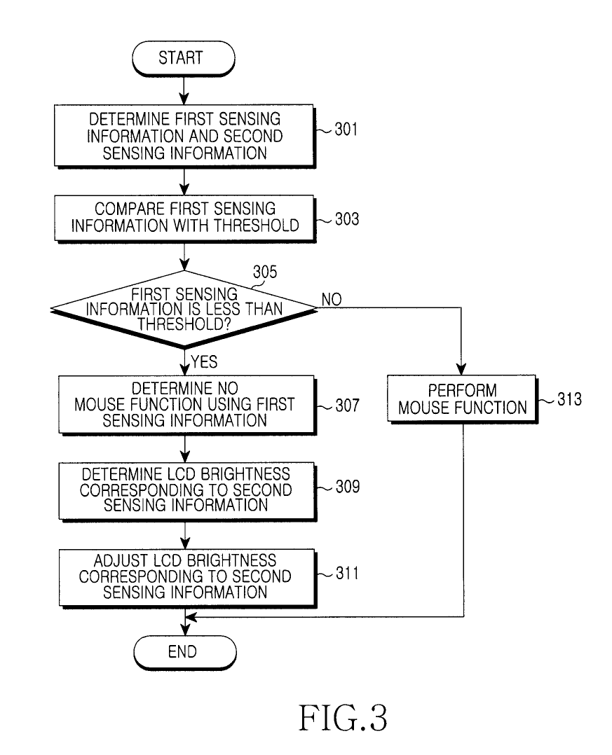

FIG. 3 is a flowchart of a method for reducing the battery power consumption in the portable terminal according to another exemplary embodiment of the present invention.

In FIG. 3, it is assumed that the portable terminal offers the optical mouse function and when not conducting the optical mouse function, the optical mouse serves to provide the sensing information related to its surrounding.

In step 301, the portable terminal determines first sensing information and the second sensing information. Herein, the first sensing information indicates the sensing information for determining the object placed on the portion controlling the mouse operation of the portable terminal. The first sensing information determines whether the user's input for the mouse function is detected in the portion for the mouse function, and the second sensing information is the value, which is used to control the LCD brightness in the portable terminal to reduce the battery power consumption of the portable terminal. The portable terminal uses the second sensing information as the sensing information of the light sensor and thus uses the brightness levels around the optical mouse function.

In step 303, the portable terminal compares the determined first sensing information with a preset threshold. More specifically, the portable terminal determines whether the first sensing information is greater than or less than the threshold. Herein, the preset threshold determines whether an object, such as a finger or stylus pen, is placed on the portion controlling the mouse operation of the portable terminal. When determining the first sensing information greater than the threshold, the portable terminal can determine that the user's input is detected in the portion of the mouse function to execute the mouse function.

The threshold may be defined by a distance from the object to the internal sensor. For example, the value corresponding to the distance when the object covers the mouse can vary depending on the distance from to the internal sensor. The threshold can vary depending on the mechanical design choice and the sensitivity of the mouse.

When determining the first sensing information greater than the threshold in step 305, the portable terminal determines the detection of the input for the mouse function and performs the mouse function in step 313.

When determining the first sensing information less than the threshold in step 305, the portable terminal determines no detection of the input for the mouse function in step 307.

In step 309, the portable terminal determines the brightness of the LCD corresponding to the second sensing information using the second sensing information determined in step 301. Herein, the second sensing information indicates the value for controlling the LCD brightness in the portable terminal to reduce the battery power consumption of the portable terminal as stated above.

In step 311, the portable terminal adjusts the brightness of the LCD according to level of the second sensing information.

More specifically, when the optical mouse is not operative, the portable terminal uses the second sensing information to selectively adjust the battery power consumption, thus enhancing the battery life. When the second sensing information indicates the bright surroundings, the portable terminal lowers the brightness of the LCD. When the second sensing information indicates the dark surroundings, the portable terminal raises the brightness of the LCD.

To provide the mouse function in the portable terminal according to the teachings of the present invention, two values are determined. The Squal value for determining an object placed on the mouse, and the Shutter value indicative of the light amount around the mouse are determined. In the exemplary embodiment, when the object is placed on the mouse, the mouse function is controlled in the conventional manner. When no object is placed on the mouse, the information indicative of the ambient light is used in place of the information of the light sensor without having to use a separate light sensor. Thus, the manufacturing cost of the portable terminal can be lowered and the battery power consumption problem can be addressed.

As stated above, the battery power consumption can be reduced by adjusting the display brightness of the portable terminal according to the brightness around the location of the portable terminal. Without a separate light sensor for detecting the brightness around the portable terminal, the information retrieved from already existing optical mouse function is used to selectively adjust the level of LCD brightness. Therefore, the manufacturing cost of the portable terminal can be lowered and the battery power consumption can be saved without having to use the light sensor of the conventional portable terminal for regulating the brightness of the display part.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for reducing a battery power consumption in a portable terminal comprising:
a sensor for detecting a first information for determining an object input, and a second information for determining the ambient brightness; and
a controller for selectively adjusting a screen brightness of the portable terminal using the second information when the first information indicates absence of the object input.

2. The apparatus of claim 1, wherein the sensor is an optical mouse which provides a pointing function on a display screen of the portable terminal.

3. The apparatus of claim 1, wherein the ambient brightness comprises a Shutter value indicating a level of brightness around the mouse.

4. The apparatus of claim 1, wherein the sensor detects a Squal value for determining the object input.

5. The apparatus of claim 1, wherein the first information is a Squal value, and the second information is a Shutter value.

6. The apparatus of claim 1, wherein the first information and the second information are detected concurrently.

7. The apparatus of claim 1, wherein the first information and the second information are detected at different time.

8. The apparatus of claim 1, wherein the object input is a finger.

9. A method for reducing a battery power consumption in a portable terminal, the method comprising:
determining a first information for sensing an object input;
determining a second information for determining an ambient brightness; and
adjusting a screen brightness of the portable terminal using the second information when the first information indicates absence of the object input.

10. The method of claim 9, wherein the sensing an object input is performed by an optical mouse which provides a pointing function on a display screen of the portable terminal.

11. The method of claim 10, wherein the ambient brightness comprises a Shutter value indicating a level of brightness around the mouse.

12. The method of claim 9, herein the object input is a finger.

13. The method of claim 9, wherein the first information is a Squal value, and the second information is a Shutter value.

14. The method of claim 9, wherein the first information and the second information are determined concurrently.

15. The method of claim 9, wherein the first information and the second information are determined at different time.

16. The method of claim 9, wherein the first information and the second information are sensed using a optical mouse embodied in the portable terminal.

17. An apparatus for reducing a battery power consumption in a portable terminal comprising:
an optical mouse for detecting a brightness around the optical mouse for determining an object input, and if the brightness is below the threshold brightness for determining an object input, transmitting the detected brightness to a controller; and
the controller for adjusting a screen brightness of the portable terminal using the detected brightness.

18. The apparatus of claim 17, wherein the optical mouse provides a pointing function on a display screen of the portable terminal if the brightness is not below the threshold brightness for determining an object input.
